(19) United States
(12) Patent Application Publication
(10) Pub. No.: US 2014/0045419 A1
(43) Pub. Date: Feb. 13, 2014

(54) WINDOW CONDENSATION CONTROL

(71) Applicant: Joseph J. Bartmann, Appleton, WI (US)

(72) Inventor: Joseph J. Bartmann, Appleton, WI (US)

(21) Appl. No.: 14/058,472

(22) Filed: Oct. 21, 2013

Related U.S. Application Data
(63) Continuation-in-part of application No. 12/386,700, filed on Apr. 21, 2009.
(60) Provisional application No. 61/124,938, filed on Apr. 21, 2008.

(51) Int. Cl. E06B 7/12; F24F 7/06

(52) U.S. Cl. CPC E06B 7/12; F24F 7/065
USPC 454/198; 454/200

(57) ABSTRACT

A window air handler mounted to a window admits a supply of air from inside the building at the top of the window and blows that air downwardly and onto the inner surface of the window. A leg depends downwardly from an air inlet, to air outlets which express the air across the width of the window. The air can be ambient, or heated. The so-expressed air warms the glass enough to avoid condensation on the glass, or to remove and absorb condensation which has already formed on the glass. The air handler can comprise a single leg extending down along one side of the window or two legs extending down along opposing sides of the window. Air inlets are proximate the tops of the legs, and air outlets are below the inlets.

### CROSS-REFERENCE TO RELATED APPLICATIONS

This application is a Continuation-In-Part of U.S. Non-Provisional Application 12/386,700, filed Apr. 21, 2009, which is a Non-Provisional Patent Application of Provisional Application 61/124,938, filed Apr. 21, 2008, the complete disclosures of all of which are incorporated herein by reference, in their entireties.

### BACKGROUND

This invention relates generally to the problem of moisture vapor in the air in a building, and wherein the moisture vapor condenses on the building windows when the temperature outside the building is substantially colder than the temperature inside the building. It is important to maintain a certain level of humidity in the air in a so-warmed building thus to avoid drying out of sinuses and other internal and external body surfaces of people who occupy the building. For example, a relative humidity of about 30% is typically desired during winter weather in the northern part of the temperate zone.

Absolute capacity for air to hold water vapor as humidity is directly related to, among other factors, the temperature of the air. Thus, all other factors being equal, relatively cooler air cannot hold as much moisture as relatively warmer air.

The relatively warmer air inside the building and the relatively cooler air outside an intervening window set up a heat gradient which drives heat through the window by a heat transfer process commonly known as conduction. As a result of the conduction process, the outside surface of the window is relatively warmer than the outside air and the inside surface of the window is relatively cooler than the ambient air inside the building.

Absent treatment as in the invention, heat energy passes from the air inside the building and adjacent the window to the relatively cooler inside surface of the window, whereby the air adjacent the window is cooled. As the air adjacent the window is cooled, its capacity to hold water vapor diminishes, whereby the relative humidity in that air rises. If the air is cooled sufficiently, the air becomes supersaturated, and the excess water condenses as tiny droplets, commonly known as condensation, on the window glass. Such condition is sometimes known as “fog” on the window.

This relatively cooler air is also denser than the air farther from the window, and at the base of the window, whereby the cooled air falls downwardly along the surface of the window, setting up a downwardly flowing curtain of air adjacent the inside surface of the window, which decreases in temperature as the air progresses down the height of the window. As the cooled air falls, the space vacated by the falling air draws replacement room air toward the top of the window, setting up a relatively continuous flow of air which can be described as a falling curtain of air adjacent the window surface. As the replacement room air comes into proximity with the cooler window surface, the replacement air is cooled. As the replacement air is cooled, its capacity to hold water vapor diminishes. If the temperature of the replacement air drops low enough that the water holding capacity drops below the quantity of water which is already entrained in the replacement air, water vapor in the replacement air condenses on the window glass. As additional room air is drawn into the falling curtain, water vapor can continue to condense on the window glass. Condensation thus creates a first problem of obscuring, or partially obscuring, visibility through the window.

As a given mass of air traverses in a downward direction along the inside surface of the window, that mass of air transfers heat to the surface of the window whereby the temperature of the air continues to fall as that mass of air traverses down along the inside surface of the window.

As the relatively continuous flow of cool air downwardly along the inside surface of the window continues, the quantity of water condensed on the window glass increases, and eventually becomes great enough that the tiny droplets coalesce into relatively larger droplets or drops. The relatively larger droplets or drops continue to coalesce with each other and with additional ones of the tiny droplets until the growing drops become large enough to be drawn by gravity downwardly along the inside surface of the window. These coalesced drops move by gravity to the bottom of the window, where they typically stop and gather, first on an underlying portion of the frame of the sash. As the quantity of water on the underlying portion of the frame of the sash increases, the drops, themselves, coalesce with each other and an overflow quantity of water runs down the inside surface of the frame of the sash to the window sill.

The condensed water typically remains on the window sill and sash frame for extended periods of time until the condensation process stops when the temperature gradient is less, or the humidity in the air inside the building is less, and the condensed water is absorbed back into the air in the room. As the water remains on the sill and sash for extended periods of time, the water penetrates the finish coating on the wood and deteriorates the wood substrate of the window sash frame and the window sill thus creating a second problem of causing deterioration of the wood which serves as the substrate for the sash and/or the window frame.

In addition, the falling curtain of cooler air creates a third problem in that the cool air falls close to the floor and creates a cold draft close to the floor, which can result in thermal discomfort to people in the room as they experience “cold feet”.

Given the above scenario, water may remain on part of the sash frame and the sill of the window frame for prolonged periods of time. While the occupants of the building can remove the condensed water by e.g. wiping up the water with absorbent cloths or paper towels, such removal requires continued vigilance and action by the occupants, which may not occur. Rather, the condensed water typically remains in pools, puddles, and/or coalesced drops on the window sill and sash frame, and the like for prolonged periods of time.

As indicated above, as the water sits on the sash and sill, the water works its way through the protective coatings on the e.g. wood substrate, which protective coatings are commonly used to protect the wood substrates from which the sash and sill are commonly made. Commonly-used protective coatings are effective to prevent penetration to the underlying wood substrate for short periods of time, but are not effective to prevent penetration to the underlying wood when the water is present on the coated surface for prolonged periods of time. Typically, the first evidence of damage by the water remaining on the sill and sash for prolonged periods of time is the development of what is commonly known as “water spots” on the sill and sash.

As water continues to stand on the coated wood surfaces, or as water repeatedly stands on the coated wood surfaces, the water eventually penetrates the coating enough to wet the underlying wood. The wetted underlying wood is then vulnerable to attack by the various organisms which feed on wetted cellulose in the wood, causing deterioration of the structural capacity of the wood. Over time, the structural integrity of the wood is sufficiently degraded by such attack that the barrier function of the window is compromised such that the window must be replaced. In addition, water penetration and persistent residence of water in/on the wood can and may support growth of mold and/or mildew in the wood and in the wall structure surrounding the window installation site.

The purpose of this invention is to solve the above four problems of (i) visibility caused by fog, (ii) deterioration of the window framing caused by standing water, (iii) cold drafts caused by the movement of the chilled air along the floor of the room, and (iv) mold/mildew. The condensation gets under the sill and into the wall. The insulation becomes wet and mold begins to grow (unseen). This also ruins the wall and causes serious health issues to occupants of the building.

Condensed water on windows has long been recognized as a problem, both in terms of obscuring visibility through the window and in terms of deterioration of the window sill and the sash frame.

For example, U.S. Pat. No. 5,844,202 Alverson teaches a portable device which mounts temporarily on the dash of a vehicle. The device plugs into an outlet in the vehicle for power and blows warmed air onto the inside surface of the windshield to clear away fog and ice. Alverson thus addresses fog removal but not fog prevention.

U.S. Pat. No. 3,064,110 Vogler teaches an electrical heater inside a metal window frame. When switched on, the heater heats the metal frame, thus to vicariously heat the associated glazing by heat conducted through the frame, sufficiently to prevent water from condensing on the glass. Vogler heats the frame directly by conduction, and thus the window glazing indirectly by conduction.

U.S. Pat. No. 2,888,943 Steele teaches a window heater at the bottom of the window, which receives the falling curtain of cool air, heats that air and directs that heated air away from the window and into the room. Steele thus addresses the cold draft, but not condensation or water standing on a window frame or window sill.

U.S. Pat. No. 3,762,118 Sanders teaches a thermal insulator mounted to the outer surface of the glass at the bottom of the window, thus to maintain the bottom portion of the window at a somewhat warmer temperature, while apparently obscuring visibility through the lower portion of the window.

U.S. Pat. Nos. 4,064,666 Kinlaw, 4,408,425 Torme, and 4,966,129 Curtis teach respective methods of capturing and handling the moisture which does condense, and run down the window, but do not teach any way to avoid the condensation.

There remains a need for methods and apparatus which effectively prevent the formation of condensation on the window glazing.

There is additionally a need for methods and apparatus which avoid the need to deal with water collecting on the sash and sill.

There is further a need for methods and apparatus which address the combination of problems related to visibility through the window, cold draft close to the floor, and damage to window framing caused by standing condensed water.

### SUMMARY OF THE INVENTION

The invention comprises an air handler, mounted to a surface of a window frame or a trim piece. The air handier admits a supply of air from inside the building at the top of the window and blows that air along a downwardly-depending air path and onto the inner surface of the window. The air handler has one or more legs depending downwardly from an air inlet, to air outlet apertures which express the air in a direction which is generally transverse to the height of the window. The air can be expressed onto the window at ambient temperature or, in some embodiments, supplemental heat is added to the air such as from an electric heater.

Thus, the invention provides a convection curtain of air, from inside the building, adjacent the inside surface of the window/glazing, which curtain of air warms the inside surface of the glass enough that condensation does not form on the glass, or the curtain of air removes and absorbs condensation which has already formed on the glass.

In some embodiments, the air handler comprises a leg which extends down along the side of the window. An air inlet is proximate the top of the window. The air outlets are below the inlet. First and second legs may extend down along opposing sides of the window, thus to project air onto the window glazing from both the left and right sides of the window.

In a first family of embodiments, the invention comprehends a window air handler adapted to attenuate moisture condensation on a glazing of an installed window in a building, the window including a glazing, and having a top and a bottom, a left side and a right side, a height between the top and the bottom, a width between the left side and the right side, and an inside glazing surface facing an interior of the building. The window air handler is external to, and separate and distinct from, the window, and comprises a header: a first leg extending down from the header and alongside more than half the height of the window glazing; an air inlet adapted to admit air from an ambient environment inside the building proximate the top of the window when at least one of the header and the first leg is mounted to one of the window or the building such that the header is proximate the top of the window; an air outlet structure comprising a first set of two or more air outlet apertures in the first leg, below the air inlet; an air flow path between the air inlet and the air outlet apertures whereby air enters the air handler proximate the top of the window and flows downwardly to the air outlet apertures, below the air inlet; and a blower in the airflow path between the air inlet and at least one of the air outlet apertures, the blower blowing air out of the air handler at the at least two air outlet apertures.

In some embodiments, when the air handler is installed at the window, the header extends across at least a portion of the width of the window, and the air outlet apertures are spaced along a length of the first leg, with a distal such aperture being proximate a remote bottom end of the first leg.

In some embodiments, the blower is inside the header, above the window glazing, and above the first leg.

In some embodiments, the blower is inside the first leg.

In some embodiments, the first leg extends alongside the window for substantially the full height of the window.

In some embodiments, a relatively smaller cross-section remote portion of the first leg is slidably and telescopically received into a relatively larger cross-section proximal portion of the first leg, the remote portion of the first leg having a first length and the proximal portion of the first leg having a second length, whereby the remote portion of the first leg can be extended from, and retracted into, the proximal portion of the first leg, and wherein at least one of the outlet apertures is disposed in each of the remote portion of the first leg and the proximal portion of the first leg.

In some embodiments, the header has a useful width sufficient to extend across the width of the window, and wherein the header extends along the top of the window, from a left side of the window to a right side of the window, and wherein a relatively smaller cross-section first portion of the header is slidably and telescopically received into a relatively larger cross-section second portion of the header, whereby the first portion of the header can be extended from, and retracted into, the second portion of the header, whereby the header can be telescopically adjusted in width across the width of the window, and the first leg an be telescopically adjusted in height along the height of the window.

In some embodiments, the window air handler further comprises a heater in the downwardly-extending first leg.

In some embodiments, the first leg has a useful length sufficient to extend substantially the full height of the window, down along the right side of the window, the air handler further comprising a second telescoping leg, in gaseous communication with the header and extending down along the left side of the window, the second leg having a second set of air outlet apertures expressing air onto the window glazing from the left side of the window.

In some embodiments, the air inlet comprises a first air inlet between a relatively central portion of the width of the header and an uppermost one of the air outlet apertures in the first leg, and thus provides for air flowing through the first leg, the air handler further comprising a second air inlet between the central portion of the width of the header and an uppermost one of the air outlet apertures in the second leg, and thus providing for air flowing through the second leg.

In some embodiments, the blower is disposed between the first air inlet and the first set of outlet apertures in the first leg, the air handler further comprising a second blower between the second air inlet and the second set of outlet apertures in the second leg, an air flow barrier being disposed in the header between the first and second blowers such that air flowing between the first air inlet and the outlet apertures in the first leg is segregated from the air flowing between the second air inlet and the outlet apertures in the second leg.

In some embodiments, the air handler further comprises first and second sensors sensing condensation conditions at first and second spaced locations on the glazing of the given window in association with respective air flows being expressed from the air outlet apertures in the first and second legs, and a controller receiving condensation condition information from the first and second sensors, and controlling operation of the first blower according to the information received from the first sensor, and separately controlling operation of the second blower according to the information received from the second sensor.

In some embodiments, the heater in the first leg comprises a first heater, and the air handler further comprises a second heater in the second leg, the controller separately controlling output of the first heater and output of the second heater according to the information received from the first and second sensors, respectively.

In some embodiments, the header has a useful width sufficient to extend across the width of the window, and wherein the header extends along the top of the window, from the left side of the window to the right side of the window, further comprising a first heater between the air inlet and the blower, and a second heater between the blower and a remote end of the first leg.

In some embodiments, the second heater extends generally continuously between a location proximate the blower and a location proximate the outlet aperture which is most remote from the blower.

In some embodiments, the second heater extends intermittently between the location proximate the blower and the location proximate the outlet aperture which is most remote from the blower.

In a second family of embodiments, the invention comprehends a window for use in a building, the window having a top and a bottom, a left side and a right side, a height between the top and the bottom, a width between the left side and the right side, and an inside glazing surface facing an interior of the building. The window comprises a window frame; a window sash; and a window air handler mounted to at least one of the window frame and the window sash, the window air handler comprising a first telescoping leg extending down along either the left side or the right side of the window, a relatively smaller cross-section lower portion of the first leg being slidably and telescopically received into a relatively larger cross-section upper portion of the first leg, whereby the first lower portion of the first leg can be extended from, and retracted into, the upper portion of the first leg, a first air inlet proximate the top of the first leg, as a first air outlet structure, a first set of two or more air outlet apertures in the first leg, below the first air inlet, and a first blower in the first leg, the first blower blowing air out of the first leg at the first set of two or more air outlet apertures and onto and across the inside glazing surface of the window, whereby air enters the air handler at the first air inlet and travels downwardly inside the first leg along the respective side of the window and is expressed from the first leg and onto and across the inside glazing surface of the window at locations below the first air inlet.

In some embodiments, the window further comprises a first heater between the first air inlet and the first blower, and a second heater between the first blower and a remote end of the first leg.

In some embodiments, the window air handler further comprises a second telescoping leg separate and distinct from the first telescoping leg and mounted to one of the window frame and the window sash at the other of the left side or the right side of the window, the second telescoping leg having a second upper end proximate the top of the window and a second lower end displaced from the top of the window, a relatively smaller cross-section lower portion of the second leg being slidably and telescopically received into a relatively larger cross-section upper portion of the second leg, whereby the second lower portion of the second leg can be extended from, and retracted into, the upper portion of the second leg, the second leg having a second air inlet proximate the top of the second leg and an air outlet structure comprising a second set of two or more air outlet apertures in the second leg, below the second air inlet.

In some embodiments, the window further comprises a third heater between the second air inlet and the second blower, and a fourth heater between the second blower and a remote end of the second leg.

In some embodiments, the window further comprises a first condensation sensor sensing condensation on the window proximate the first leg and a second condensation sensor sensing condensation on the window proximate the second leg, and a controller receiving input from both of the first and second sensors, the controller sending a first set of control signals to the first blower and the first heater in the first leg in response to input from the first sensor, and sending a second set of control signals to the second blower and the second heater in the second leg in response to input from the second sensor.

### BRIEF DESCRIPTION OF THE DRAWINGS

FIG. 1 illustrates, in pictorial view, a portable air handler situated and held on a window sill at the base of the window solely by the force of gravity.

FIG. 1A illustrates a cross-section of the air handler of FIG. 1, aid is taken at 1A-1A of FIG. 1.

FIG. 2 illustrates, in pictorial view, a window wherein an air handler is included as an integral element of the window, and is located at the base of the window.

FIG. 3 illustrates in pictorial view, with parts cut away, a window wherein an air handler is included as an integral element of the window, which air handler expresses air onto the glazing from the bottom, from the left side, and from the right side, of both the lower sash and the upper sash.

FIG. 4 is a cross-section, looking up, of a side wall of the window of FIG. 3 and is taken at 4-4 in FIG. 3.

FIG. 5 shows, in pictorial view, a window wherein an air handler is included as an integral element of the window, and expresses air onto the glazing, and wherein the air handler is connected to the building central heating system, whereby the air handler expresses warmed air from the central heating system onto the window glazing.

FIG. 6 is a block diagram representation of a system wherein multiple air handlers are linked together for control by a common computer.

FIG. 7 illustrates, in front elevation view, a portable air handler disposed on, and extending from, the top of the lower sash of a double-hung window.

FIG. 8 is a scaled-down cross-section of a window employing a portable air handler as in FIG. 7.

FIGS. 8A and 8B show a cross-section and front elevation view, respectively, of a test bed used to test an air handler of the invention.

FIG. 8C shows a front elevation view of an air handler on a double hung window, with parts of the header of the air handler cut away, illustrating use of an air intake filter, the fan, and the heater in the header, and a single downwardly-depending leg from which air is expressed onto the glass.

FIG. 8D shows a front elevation view of an air handler on a double hung window, having a telescoping header and telescoping first and second legs, with first and second air intakes, and a common controller controlling blowers and heaters in each of the legs.

FIG. 8E shows a front elevation view as in FIG. 8D but wherein the unitary air handler has been replaced with first and second air handlers, each comprising a leg extending downwardly along one of the opposing sides of the window.

FIG. 8E1 shows a cross-section of a leg, and mounting structure mounting the leg to the window.

FIGS. 9-12 show graphical representations of the interactions of air temperature, air velocity out the ducts, duct diameter, and heater output to maintain the inner glazing surface fog free under a specified set of conditions for a double hung window nominally 18 inches wide by 36 inches high.

FIGS. 13-16 show graphical representations of the interactions of air temperature, air velocity out the ducts, duct diameter, and heater output to maintain the inner glazing surface fog free under a specified set of conditions for a double hung window nominally 30 inches wide by 48 inches high.

FIGS. 17-20 show graphical representations of the interactions of air temperature, air velocity out the ducts, duct diameter, and heater output to maintain the inner glazing surface fog free under a specified set of conditions for a double hung window nominally 42 inches wide by 60 inches high.

The invention is not limited in its application to the details of construction, or to the arrangement of the components set forth in the following description or illustrated in the drawings. The invention is capable of other embodiments or of being practiced or carried out in various other ways. Also, it is to be understood that the terminology and phraseology employed herein is for purpose of description and illustration and should not be regarded as limiting. Like reference numerals are used to indicate like components.

### DETAILED DESCRIPTION OF THE ILLUSTRATED EMBODIMENTS

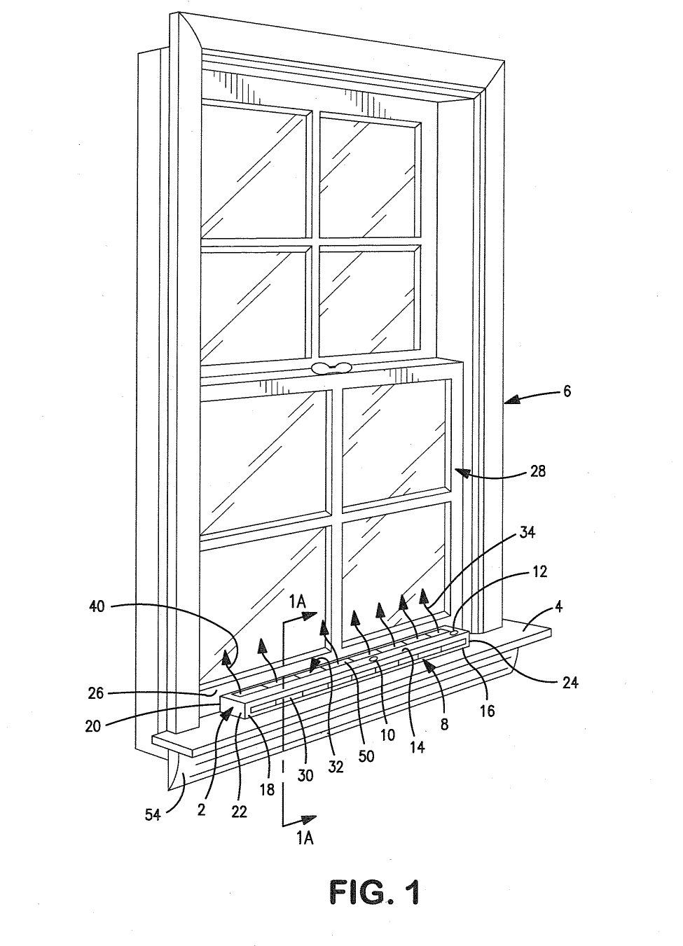

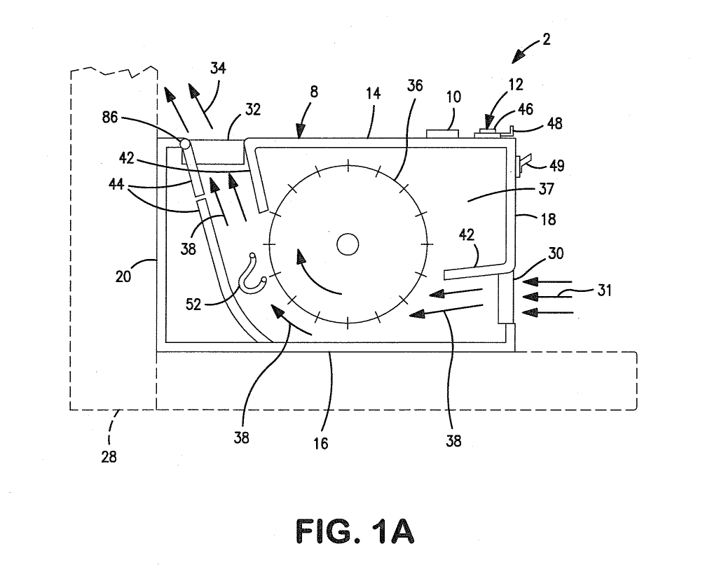

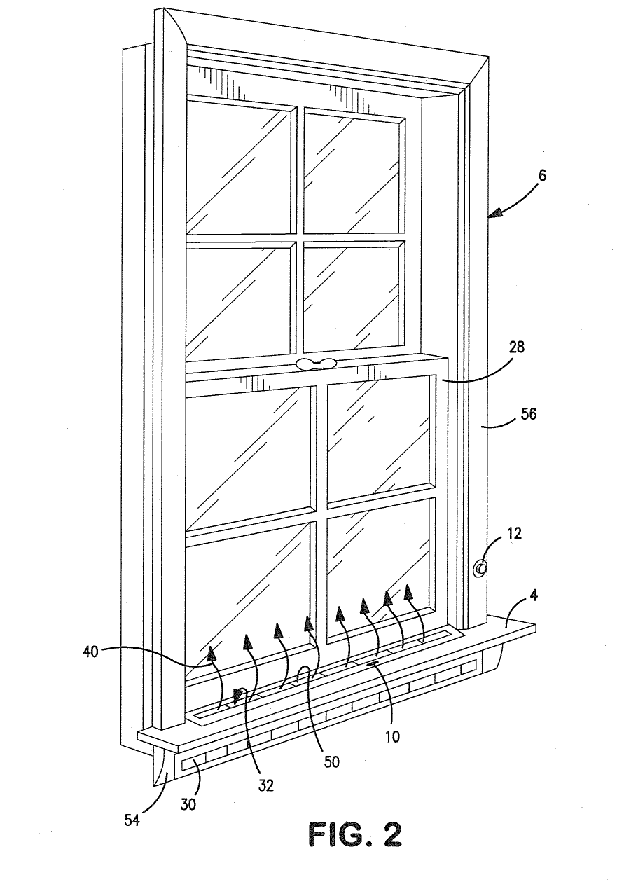

FIGS. 1, 1A, and 2 illustrate two embodiments of the invention. In FIG. 1, a self-contained portable aftermarket air handler 2 is shown resting/held only by gravity on a pre-existing sill 4 of a double-hung window 6. As illustrated in FIGS. 1 and 1A, no attachment is shown securing housing 2 to the window. Rather, housing 2 simply rests by gravity on the sill, such that moving the air handler 2 illustrated in FIGS. 1 and 1A from a first window to a second different window involves no more than picking up the air handler at the first window, optionally unplugging the air handler from a power source/plug, carrying the air handler to the second window and placing the air handler on the sill of the second window. The air handler is held/maintained on the sill of the second window solely by gravity, and can then be plugged into a power source close to the second window as needed, and is then ready for service.

Air handler 2 includes a housing 8, relative humidity sensor 10 mounted on the housing, and condensation controller 12 mounted on the housing. Housing 8 has a top wall 14, a bottom wall 16, a front wall 18, a back wail 20, and left and right ends 22, 24. In use, the back wall 20 of air handler 2 is generally in contact with, or closely adjacent, the inner surface 26 of the bottom of the lower sash 28 of the window.

If desired, a quick-release attachment system such as a small amount of hook and loop fastener material can be attached to the facing surfaces of the window sill and the bottom wall of the housing, thus to temporarily mechanically restrain the air handler, beyond the restraints of gravity, while effecting an automatic release when lifting force is applied to housing 8 e.g. at an end of the housing displaced from such temporary restraint.

Referring now to FIG. 1A, a first air inlet grill 30 is disposed only in the front face of the air handler such that all of the air inlet openings are displaced a few inches from the surface of the lower sash. Inlet grill 30 receives ambient air from inside the house as indicated by arrows 31. Remembering that the air adjacent the glass is cooler than air spaced from the glass, positioning the air inlet so as to draw air from a location spaced from the glass means that the air entering the housing is warmer than the air immediately adjacent the glass. A second air outlet grill 32 on the top of air handler 2 directs air out of the top of the air handier housing as indicated by arrows 34. Thus the air being expressed onto the glass is almost always warmer than the air which is being pushed away from the glass by the air being expressed from the air handler.

In the embodiment illustrated in FIGS. 1 and 1A, both inlet grill 30 and outlet grill 32 extend substantially the full width of housing 8.

One or more small, low volume, driven blowers 36 are mounted in the chamber 37 inside housing 8 and draw air in through inlet grill 30, along an air path such as that illustrated by arrows 38, between the air inlet and the air outlet, and express the air upwardly and out through the top of the air handler housing at air outlet grill 32 and alongside, optionally against, the bottom of the adjacent lower sash of the window, as illustrated by arrows 34 coming from the top of the air handler.

As illustrated in FIG. 1A, baffles 42, 44 help control the direction of flow of air in chamber 37 as illustrated by arrows 38, and direct the air flow from inlet grill 30 as accelerated by rotation of blowers 36 toward and through outlet grill 32, and thus toward the glazing as the air is expressed from the air handler upwardly along the inner surface of the glazing.

Thus, air enters housing 8 at inlet grill 30 and is drawn along a generally straight-through path by, and to, blower 36. Blower 36 then pushes the air along the path defined by baffles 42, 44 and arrows 38 in the generally straight-through path, illustrated in FIG. 1A, to outlet grill 32. As seen in FIG. 1, air entering the air handler through grill 30 at the left side of the air handler exits the air handler through exit grill 32 at the left side of the air handler.

Similarly, air entering the air handler through the center, or through the right side, of the air handler at grill 30, exits the air handler through exit grill 32 at the respective center, or right, side of the air handler. Thus, the interior of the air handler housing 8 provides a relatively straight-through path of travel, unrestricted by cross-section changes except as the air moves past blower 36. Thus, the left-to-right dimension (FIG. 1) of the air flow path is relatively constant between inlet grill 30 and outlet grill 32. And the air chamber does not act as a pressure accumulator except for that pressure required to move the air along a generally constant cross-section area of the path of travel.

Such upward expression of the air along the glass, which air is overall warmer than the air in the naturally-occurring down-flow of cold air at the inner surface of the window, generally prevents the naturally-occurring down-flow of cold air along the inner surface of the window.

Sensor 10, as illustrated in FIG. 1, is a relative humidity sensor. Sensor 10 is positioned to sample air proximate the bottom of the window. Air which falls by natural convection proximate the cool window glass, when the air is not being actively expressed from the air handler, reaches its coolest temperature after completing its downward path along the inside surface of the window. Accordingly, by positioning sensor 10 so as to be located, in use, proximate the bottom of the window, proximate the inner surface of the window, and in the air flow path of such natural convection air flow, sensor 10 is located to sense the air at approximately its coolest temperature, which is the temperature at which moisture vapor is most likely to condense from the naturally-falling air.

Sensor 10 feeds its sensed humidity to controller 12 by a connecting wire, not shown. Controller 12 is a variable humidistat which can activate an electrical circuit when the relative humidity sensed by sensor 10 reaches a predetermined/pre-set level. Condensation controller 12 is electrically connected to blower 36, illustrated in FIGS. 1A and 5. The relative humidity at which controller 12 is to activate the circuit is set by the user by turning a dial 46 on the controller. The user also sets a timer 48 on controller 12 which determines how long the blower runs when activated by the controller. Timer 48 can be set for e.g. as little as 2 minutes, for as long as 60 minutes, or any time interval in between, or to run continuously. In a typical 30 percent relative humidity environment, fan run time of about 5 minutes to about 15 minutes is adequate to prevent fog formation or to remove fog already formed on the window glass.

Controller 12 can, in the alternative, be a digital touch pad or other digital user interface which enables the user to specify the triggering relative humidity and/or the time over which air is to be expressed along the window glazing.

When the set relative humidity is reached, controller 12 activates the electrical circuit, turning on the blower. Once the blower is turned on, timer 48 begins counting down the set time until the timer shuts the blower off unless sensor 10 senses relative humidity greater than the set relative humidity. If the sensed relative humidity corresponds to the set relative humidity, or is greater, blower 36 continues to operate until the sensed relative humidity has fallen enough to no longer correspond to the set relative humidity, whereupon the blower then turns off.

With the blower off, the relatively cooler window glass again cools the air in its vicinity, again setting up the natural downward flow of cooler air near the window and passing close enough to sensor 10 that sensor 10 can sense the general humidity level in the falling curtain of cooled air. As the thus-cooled air moves past sensor 10 as the blower is in the “off” setting, the sensor monitors the changing relative humidity of the falling curtain of air coming off the window, and sends its sensed values to controller 12. When the sensed values again reach the relative humidity setting at controller 12, the controller again turns on blower 36.

A master on/off switch 49 (FIG. 1A), or a circuit breaker, controls power to the electrical circuit which powers sensor 10, controller 12, and blower 36. Master switch 49 is turned off by the user seasonally when the heating season has ended.

In some embodiments, the sensor and controller are eliminated whereby blower 36 is controlled directly by the master switch. In such embodiments, once activated, the blower runs continuously until the user turns the switch off.

In especially adaptable air handlers of the invention, blower 36 has a variable speed motor, and controller 12 has a third variable speed control feature whereby the user can set and vary the speed of blower 36 so as to control the rate at which air is expressed from housing 8 at outlet grill 32. In the alternative, conventional circuitry in controller 12 can increase or decrease blower speed according to the extent by which air temperature and/or relative humidity, as sensed by sensor 10, deviates from a pre-set temperature and/or humidity.

It is typically desirable to provide relatively uniform rates of outflow of air across substantially the full width of the air handler, in order to effectively treat the full width of the window illustrated in FIG. 1. Such uniformity of air flow rate can be achieved by using an elongate relatively slow speed blower which extends substantially the full width of the air handler. In the alternative, one or more smaller blowers, each substantially shorter than the width of the air handler, can be used, aligned along the width of the air handler, and all driven at generally the same speeds. In either case, the air path between the inlet grill and the outlet grill extends substantially the full width of housing 8 whereby housing 8 can be substantially a single-chamber defined by the exterior walls which enclose the housing, in combination with the respective louvers and baffles.

In the alternative, air inlet grill 30 can have a reduced width between ends 22, 24 and the air flow path can define a reduced-cross-section throat, relative to the width of the housing, and containing a reduced-size/shorter blower: whereupon the air is thence channeled along one or more expanding air flow paths to outlet grill 32.

In yet another alternative, the air flow path can include a pressurized, low pressure, chamber wherein the rate at which air is expressed from the outlet grill is controlled by the sizes of the air outlet openings 50 in outlet grill 32.

Returning to FIG. 1, because the air is drawn, as ambient room air, from a region proximate but displaced from the lower sash, though conveniently close to the sash, because that air is relatively warmer than the inner surface of the window glass, the air expressed toward the glass maintains the temperature of the glass at its inner surface warmer than the temperature of that surface absent the intervention by the air handler and the methods disclosed herein, Since the glass is relatively warmed, the tendency of moisture in the air to condense on the glass is reduced. The greater the rate of flow of the applied air along the window surface and/or the greater the temperature of the air applied along the window surface, the higher the temperature of the inside surface of the glazing, and correspondingly the less the tendency of the air moisture to condense on the glass. Given a typical 30 percent winter relative humidity in heated buildings occupied by people, all condensation can typically be prevented by applying a gentle flow of upwardly-moving ambient room air onto the inside surface of the window.

Application of the invention disclosed herein is a compromise between heat loss and prevention of condensation. Condensation is prevented by warming the inner surface of the window using e.g. ambient air from the room to heat the surface of the glass enough that the humidity in the ambient room air does not condense. However, such warming of the inside surface of the window glass does extract an incremental amount of heat from the ambient air and transfer that heat to the glass. Such heat loss is automatically and generally made up by the building central heating system in the normal course of heating the building through conventional registers or radiators according to a thermostat setting used by the central heating system to heat the building. The amount of heat used in incrementally heating the window is related to the rate at which the air flows over the inner surface of the glass, and the temperature of that air. Accordingly, the rate of air flow and/or the heat applied to the air is controlled so as to apply, with suitable margin for fluctuating conditions, just the right amount of heat to the glass to prevent condensation. The lower corners of the glass are the areas most prone to condensation, and so enough air is applied, optionally including at or proximate the lower corners, to prevent condensation in the lower corners.

By contrast, the invention does not contemplate applying a normal full register output of heated air, from the building central heating system, onto/along the window; as such quantity of heat transfer is normally excess to the amount needed by the window for preventing condensation, and wastes heat by transferring, to the glass, more heat than is needed to avoid condensation forming on the window. Rather, the amount of air and heat needed to avoid condensation is typically far less than the amount of heat produced by the building heating system. Accordingly, such centrally-heated air, where used, is only a small fraction, substantially less than half, the amount of air normally expressed through a zone-sized air diffuser.

By zone-sized air diffuser is meant an air diffuser adapted to convey space heating heat for a medium size room of about 1000 cubic feet to about 2000 cubic feet.

In some embodiments, the air handier includes a heater 52 (FIG. 1A) which heats the air passing through the air handler. The heater can be an e.g. electric resistance heater powered from the national electric grid, optionally in the same circuit as the blower and controls, or can be powered by a solar heater or other heat source. Heater 52 is sized and configured to apply a limited amount of heat to the air passing through the housing. The amount of heat applied increases the air temperature by up to about 30 degrees F., typically no more than 20 degrees F., above the ambient room temperature. Thus, if ambient temperature is e.g. 70 degrees F., and the outside air temperature is no colder than minus 40 degrees F., the air expressed from air outlet grill 32 is typically no more than plus 100 degrees F., typically up to about plus 90 degrees F. Thus, the function of heating the air is not to provide comfort to people in the building by a perception of warm air; but rather to provide increased water holding capacity in the air in order to remove condensation from the glass as well as to incrementally heat the glass so as to prevent water vapor from condensing on the glass.

The aftermarket air handler 2 shown in FIG. 1 can be applied to any existing window which has a sill deep enough to support the front-to-back depth of housing 8. In such instance, all support for the air handler is provided by the window sill such that the air handler is fully supported by the force of gravity holding the housing against the support of the sill. Where there is no sill, or the sill is too narrow to receive air handler 2, suitable hangars, bases, brackets, or other supports, not shown and not otherwise needed, can be used to suspend or otherwise maintain the air handler in a desired location adjacent the window.

In some implementations, rear wall 20 is displaced from the inner surface of the sash whereby air outlet grill 32 can be located in the rear wall 20 of the housing of the air handler. However, the direction of flow of a substantial portion of the air, generally all of the air, relative to window 6 is still upwardly.

Power to run the blower(s), sensor 10, control 12, where used, and optionally heater 52, can be provided from a conventional outlet connected to the national electric grid, from photovoltaic cells, from a battery charged by photovoltaic cells, or from other desired power source.

The embodiment shown in FIG. 2 illustrates the same principles as seen in FIG. 1, but with the air handler built into the window as an integral part of the window structure. Thus, air inlet grill 30 is in the lower window trim element 54 below sill 4, and outlet grill 32 extends through the top of the sill. Housing 8 and blower 36, along with the air flow path 38, are inside the bottom of the window structure between sill 4 and trim element 54, and thus are not visible in FIG. 2. In some embodiments, not shown, housing 8 is eliminated and a suitably structured chamber 37 in the window framing assembly functions in a corresponding capacity.

Sensor 10 is mounted on air outlet grill 32. Controller 12 is mounted on window side trim element 56. Wiring connecting controller 12, sensor 10, and blower 36 are contained internally within the window structure. Wire connectors releasably connect the wiring between controller 12 and the sensor and blower. Air inlet grill 30 and air outlet grill 32 are removable from the window structure to enable cleaning the air path and servicing blower 36 and the electrical connectors.

The principles of operation of the air handler illustrated in FIG. 2 are the same as those for operating the self-contained portable air handler illustrated in the embodiment of FIG. 1.

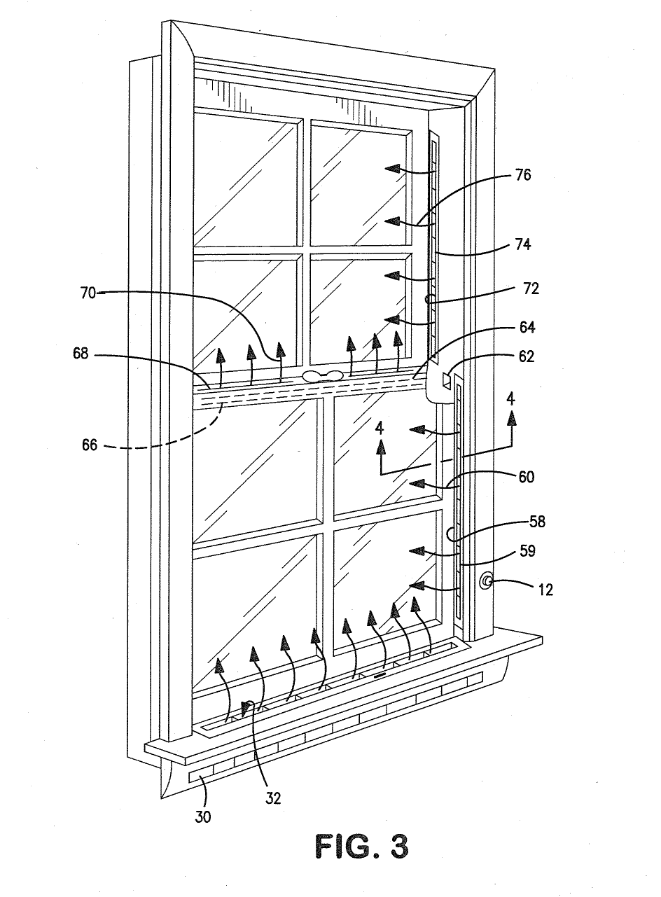

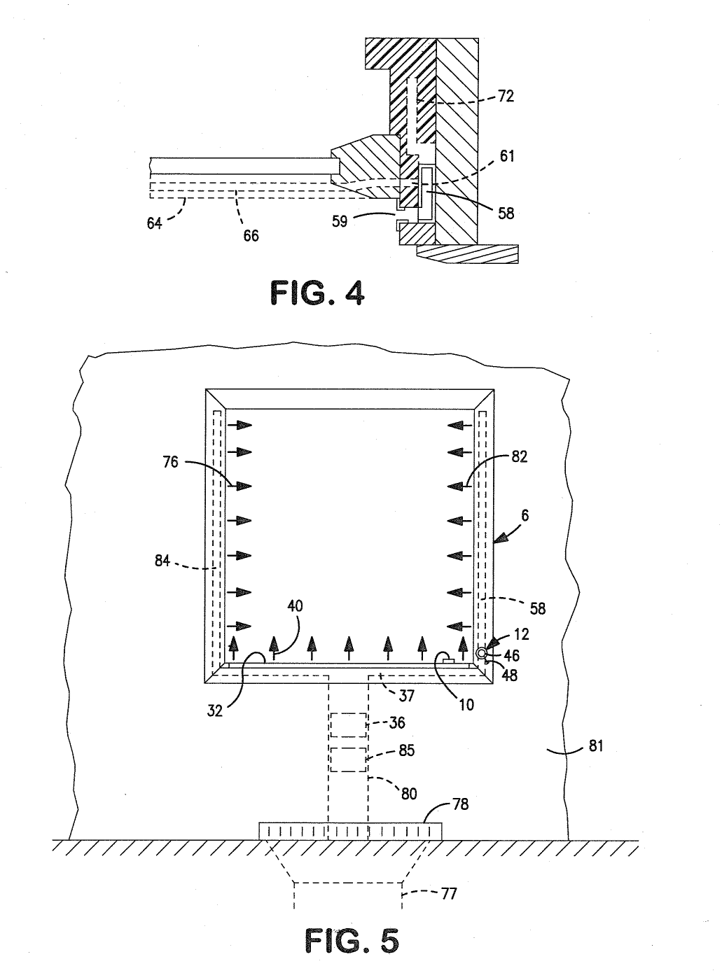

The embodiments illustrated in FIGS. 3 and 4 are similar to the embodiment illustrated in FIG. 2, with the addition of air flows onto the window from additional air chambers. The structure described in FIG. 2, which establishes the air flow path which exits the air handler at air outlet grill 32 at the bottom of the window, is maintained, including at chamber 37. A second air flow chamber 58 connects to, communicates with chamber 37 inside window frame 39 and extends upwardly inside the window frame and along the right side of the window frame. A second air outlet grill 59 communicates with second chamber 58 so as to express a gentle flow of air onto the lower sash from the right side of the window frame as illustrated by arrows 60.

As illustrated in FIGS. 3 and 4, a chamber feed 61 extends from second chamber 58 toward the surface of the window frame which faces lower sash 28 at the upper element of the lower sash and terminates at opening 62. An intake opening at the right side of the upper element 64 of the lower sash leads to a third chamber 66 in the upper element 64 of lower sash 28, which third chamber extends inside upper element 64 for substantially the full width of the lower sash. The intake opening at the right side of the upper element is in fluid communication with the second chamber when the lower sash is closed, namely in the down position as illustrated in FIG. 3, and represents an air flow passage connecting the second and third chambers.

One or more third air outlet grills 68 in the upper surface of upper element 64 is in fluid communication with third chamber 66 and directs air from the third chamber upwardly along the inside surface of the upper sash, as indicated by arrows 70 in FIG. 3, thus to address condensation on the upper sash directly.

A fourth air chamber 72 is in fluid communication with second air chamber 58 and extends upwardly along the right side of the window frame adjacent the right side of upper sash 73. A fourth air outlet grill 74 is in fluid communication with fourth chamber 72 and expresses a gentle flow of air onto the upper sash from the right side of the window frame as illustrated by arrows 76.

A fifth air chamber is in fluid communication with the first bottom air chamber 37 and extends upwardly from the first bottom air chamber 37 inside the left side of the window frame, generally to the top of the lower sash. A fifth air outlet grill is in fluid communication with the fifth chamber and expresses a gentle flow of air onto the lower sash from the left side of the window frame.

A sixth air chamber is in fluid communication with the fifth chamber and extends upwardly from the fifth air chamber along the left side of the window frame adjacent the left side of upper sash 73. A sixth air outlet grill is in fluid communication with the sixth air chamber and expresses a gentle flow of air onto the upper sash from the left side of the window frame.

While the fifth and sixth chambers and the fifth and sixth air outlet grills are not shown, these elements are generally mirror images, in structure, in location, and in function to the respective air chambers and air outlet grills on the right side of the window, with the exception of air chamber feed opening 62. While feed opening 62 is illustrated on the right side of the window frame, the third chamber can as well be fed from the left side of the window frame, or from both sides of the window frame, by fabricating such feed opening in the left side of the window frame, fed from the fifth air chamber, and communicating with a corresponding intake opening on the left side of the third air chamber.

FIGS. 3 and 4 thus illustrate the principle that the gentle flow of air can be expressed onto the window from multiple directions. It is contemplated that generally horizontal air feeds through air outlet grills can be employed without the upward feeds as at air outlet grills 32 and 68, or the upward feeds can be employed without the horizontal air feeds.

FIG. 1A illustrates use of a heater inside the air chamber 37. Such heater can be used only inside air chamber 37 or can be used in more than one of the air chambers. Heating the air incrementally e.g. by 20 to 30 degrees F. above ambient room temperature increases the water-holding capacity of the air while limiting the additional heat loss at the window glazing. By contrast, heated air from the building central heating system is typically at least 100F to 120F. So in general, the temperature of the heated air being expressed from the building central heating system is greater than optimum for the purpose of avoiding condensation on the windows. In addition, the typical rate of flow of air through the building central heating system is greater than desired in the invention and will result in more heat loss than is necessary to accomplish the objectives of the invention. Accordingly, feeding heated air from the building central heating system at normal heated temperatures and at normal air flow rates is not within the scope of the invention.

FIG. 5 illustrates a compromise embodiment which uses a throftled-down extract of heated air from the building central heating system, modified by a positive displacement blower which meters the air from the heating system feed to the window air chambers at a desired rate of gentle air flow. Using heated air from the building central heating system takes advantage of the cost effectiveness of heating air using the central heating system burner. Using the positive displacement blower controls and limits the amount of air which is expended at the window surface. Use of the warmer-than-needed air from the central heating system is balanced against the typically greater cost efficiencies of the central heating system as the source of heat, compared to a local e.g. electrical resistance heating unit in the air handier.

Referring now to FIG. 5, the simplistic embodiment shown there illustrates a single window pane/glazing in a rectangular frame. A conventional furnace duct 77 feeds warmed air to a conventional space-heating heat diffuser 78 in proximity with the window. A portion of the warmed air is bled off into a reduced-size tap duct 80, which is shown in dashed outline because duct 80 is hidden behind the conventional e.g. sheetrock layer which forms the inner face 81 of the wall. Tap duct 80 extends upwardly toward window 6 and terminates at air chamber 37, thus providing fluid air communication between duct 77 and air chamber 37.

A positive displacement blower 36 in tap duct 80 meters the air to air chamber 37. Air chamber 37 feeds a gentle flow of a first portion of the air in an upwardly direction as indicated by arrows 40 along the inside surface of the window through an air outlet grill 32 at the bottom of the window, and feeds second and third portions of the air into an upwardly extending second chamber 58 and an upwardly extending fifth chamber 84. The second and fifth chambers communicate with respective air outlet grills in generally horizontally expressing respective gentle air flows along the inside surface of the window as indicated by arrows 76 and 82. The user controls operation of the positive displacement blower 36 in the embodiments which employ such blowers, using controller 12, including dial 46 and timer 48.

While a positive displacement blower has been illustrated in FIG. 5 to control air flow, and baffles/louvers 44 have been illustrated in FIG. 1A to direct that air flow, a wide variety of structures are contemplated as being available to control the rate of flow of the air, and to shut off air flow as desired, in any of the embodiments.

A master control valve, such as a damper 85, is located in tap duct 80. Damper 85 provides an overall open-closed capability to the flow of air in tap duct 80. Damper 85 is opened during the winter heating season to allow passage of warmed air and is closed during the summer air conditioning season to generally prevent passage, onto the window glazing, of air cooled by the air conditioning system.

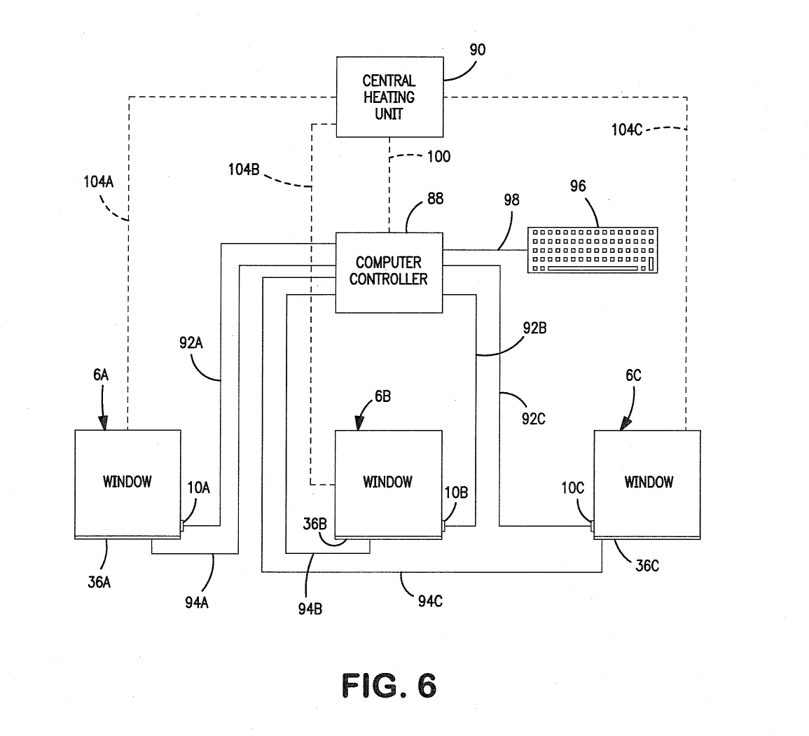

In some embodiments, the building central heating system blower is set up to run constantly as a way of maintaining constant air circulation and thus good mixing of the air throughout the building space controlled by the space heating system. Where the blower is so set up to run constantly, a portion of that constant air supply is constantly fed to tap duct 80. Given such constant air flow supply, blower 36 can be deleted and the air flow rate is controlled by damper 85 in combination with sensor 10 and the corresponding condensation controller 12 or computer controller 88 discussed following with respect to FIG. 6.

The above description has focused on a single window. And one or more individual windows can be so controlled to eliminate the formation of condensation on the respective window. An alternative is to control multiple windows, optionally all the windows on a floor of a building, or all the windows in the building, using a computer controller, such as a digital computer.

A block diagram representation of such system is shown in FIG. 6. FIG. 6 shows a controlling computer 88, three windows 6A, 6B, 6C, and a central heating unit 90. Each respective window has a blower 36A, 36B, 36C, and a sensor 10A, 10B, 10C. Each sensor is connected to computer 88 by a connecting communication link 92A, 92B, 92C. Each blower is connected to computer 88 by a connecting communication link 94A, 94B, 94C. A computer input platform e.g. keyboard or key pad 96, is connected to computer 88 by a communication link 98.

Computer 88 is shown connected by dashed communication link 100 to building central heating unit 90. Central heating unit 90 is connected by dashed lines 104A, 104B, 104C representing heating air conduits connecting to respective windows 6A, 6B, 6C.

Referring to FIGS. 1-5 and 1A, only the embodiment of FIG. 5 suggests sourcing the air for blower 36 from the central heating system. Accordingly, the dashed links 104A, 104B, 104C between the central heating unit and the respective windows and between the central heating unit and the computer, are all optional and are not necessary connections. Where the central heating unit is used, the air ducting to the air handlers 2 is sufficiently reduced in size, or otherwise throttled down, such as by damper 85, and optionally a positive displacement blower 36, that the air flow from air outlet grills 32 is a gentle flow along the surface of the respective window.

As used herein, a central heating unit is a heating device which provides general ambient air heating to a substantial portion of a building such as to multiple rooms, to a heating zone, or to the entire building. The heat output from such heating unit may be controlled by multiple spaced thermostats, all feeding to one or more space heating units which generate the heat, whether from combustion, heat pump, or non-conventional e.g. renewable heat source, for generally heating the space, the furniture, and the fixtures housed inside the building. Temperature of heated air outputted from such heating unit at steady-state operation is typically at least about 120 degrees F. or greater, though lower temperatures are contemplated as the industry strives to capture greater efficiency from such heating systems. Especially in residential heating systems, the heated air is commonly expressed into the heated air space of the building ate temperature which feels warm to a person who samples or senses the air flow at the diffuser.

Where a central heating system is used as the source of air for air handlers 2, throttling down the air flow can be an important feature of the air handling system of the invention in order to not be expressing an unnecessary amount of warmed air along the relatively cooler surface of the glass; thus to limit the amount of heat which is lost through the glass and which heat loss is associated with air handling as taught herein, while effectively controlling the formation of condensation on the respective window. In such instance, the air can be throttled by e.g. damper 85, or positive displacement blower 36, or both.

It will also be recognized that closing off tap duct 80 during the air conditioning season, to avoid blowing cold air onto the window glass, is an important feature of those embodiments which use air from, and/or air ducting connected to, the building central heating system. Thus, some structure must be provided to close off tap duct 80 as seasonally needed. Damper 85, or other effective closure structure, can serve such purpose.

Recognizing the compressibility of air, the phrase “positive displacement blower” is a relative term, and refers to blowers which can be used to generally meter a flow of air including throttling down an incoming air pressure to provide a lower-pressure, more gentle, output at a relatively predictable and consistent air flow rate.

Still referring to the embodiments which use input air from the central heating system, computer 88 continuously monitors both the sensors 10 and the central heating unit. When a sensor triggers a computer command for air to be blown along a window, computer 88 queries the central heating unit. If the central heating unit is producing and supplying a warm air flow, the computer calculates and sets a suitable opening on the respective damper 85 accordingly, and starts the respective blower 36.

If, on the other hand, the central heating unit is not supplying an air flow, computer 88 sets a suitable opening on damper 85 for blower-only air draw, and starts blower 36, which thus draws air from inside the heating system air ducting. In the latter scenario, the damper is typically wider open in order to pass sufficient air mass under the influence of a less aggressive air output from blower 36, and at a relatively lower temperature, than is typically received from the blower on the central heating unit.

Where the condensation control system is not integrated into the building heating system, computer 88 monitors the sensors 10 and activates a respective blower, on a given window, when the sensor at that window reaches the triggering humidity value.

Blowers 36 can be single speed blowers, or alternatively variable-speed blowers. Input platform 96 can be used to set certain parameters, where different settings can be used at different windows, and under different weather conditions. Typical parameters which can be set for a given window are, without limitation,

(i) the humidity level which triggers activating the respective blower,

(ii) the time the blower runs before it is shut off,

(iii) blower speed/output, and

(iv) whether a heater is activated or left turned off.

The air handlers at any number of windows can be controlled by computer 88. Computer 88 can be integrated into the control system for central heating unit 90, or any other climate control computer in the building, or can be a stand-alone, separate computer, or can have advisory/information exchange communications capability with any climate control computer associated with the building central heating system.

In general, grills 30 and 32 can be similar to removable air diffuser grills commonly used in conventional forced air central heating systems, adapted to the size requirements of the air handlers employed herein. Grills 30 and 32 are typically removable from the window structure to enable cleaning the structure inside housing 8 and along the air path and for servicing blower 36 and the electrical connectors.

Grill 30, or grill 32, or both, are optionally configured to have e.g. closure louvers which can close off the air flow path at the grills and to limit the chance of items being accidentally dropped through e.g. an outlet grill. Such louvers can be controlled manually or electrically such as by activation of a two-position actuator, for example and without limitation a solenoid actuator. For example, baffle 44 can have an upper segment and a lower segment as shown in FIG. 1A; and the upper segment can pivot upwardly about a hinge 86 such that the distal edge of the baffle closes against or proximate baffle 42, thereby restricting or closing off flow of air through the housing. Such pivotation can be actuated by a lever, not shown, which is connected to baffle 44 and extends above the top of baffle 44. Such baffle can close off any portion of the outlet grill or any one or more openings in the outlet grill.

The humidity sensor illustrated in FIGS. 1-5 senses e.g. relative humidity and thus is a low-cost proxy for the potential for condensation to form on the window. And since the objective is to control condensation, sensing humidity, as a proxy for condensation, requires a degree of interpolation, and use history, to determine effective times to turn on the blower and how long to run the blower, as well as other parameters.

In other embodiments, sensor 10 can be a light-based sensor which is sensitive to prismatic effects or other light scattering as is common when condensation forms on the window glass. Such light-based sensor can be set to directly detect the presence, or absence, of such light-scattering affect at the surface of the glass. When the sensor senses a light scattering which is representative of condensation, the sensor sends a signal to that affect to computer 88, and the computer turns on the respective blower 36 and/or heating unit, depending on default input in computer 88, or overriding input from input platform 96.

Sensor 10 can alternatively sense other proxies for condensation and/or humidity in order to determine the probability that condensation has already formed on the window or that formation of condensation on the window is imminent or likely, thereby triggering the activation of blower 36 or other means to initiate flow of air along the inner surface of the window glass.

The air being moved through air handler 2 is at a relatively lower humidity, such as about 30 percent relative humidity, whereby such air can and does absorb moisture from the condensation on the glass/window. In addition to the condensation moisture being absorbed into the air moving past the glass, the warmer-temperature moving air also imparts some of its heat to the glass, whereby the temperature of the glass rises. The combined effect of the warmer air absorbing moisture and the warmer glass having less capability to attract condensation results in a decrease in moisture condensation on the glass. As the amount of condensation on the glass decreases, the light-scattering affect of the condensation decreases.

As the light scattering affect decreases, sensor 10 senses the reduced light scatter and reports such change to computer 88. As a result, computer 88 either turns the blower off or progressively incrementally reduces the speed of the variable speed blower until either the blower is turned off or initial elements of condensation light scatter again are sensed by the sensor. in the situation where the degree of condensation light scatter changes, as sensed by the sensor, the computer increments the speed of the blower up or down as needed to maintain a minimum indication of condensation light scatter from the sensor. Where a heater 52, or otherwise-heated air, is also available, computer 88 can also control heat flow relative to condensation amount, as part of the control system.

As humidity and temperature conditions at the window change, to the effect that condensation will not form with the blower off, the computer's constant monitoring of sensor input and incrementing of blower speed and optionally heat input, results in turning the blower off when no air is needed at the window surface. Thus, the combination of variable speed blower, variable heat input, light scatter-sensitive sensor, and computer control, provide the option of relatively close control of system operation to provide, on the glass surface, that minimum rate of airflow, and only as actually needed, which is the minimum required to prevent significant condensation on the window.

The benefit of such careful control of air flow and heat input is that condensation is controlled while limiting, optimizing, largely minimizing the amount of added heat lost through the window as a result of blowing the air along the surface of the window in order to heat the window surface enough that substantial quantities of condensation do not form on the window, and limiting the energy consumed by running the blower, optionally the heater in controlling formation of condensation on the window.

The invention has been presented here in the context of the four-fold objectives of

(i) preventing cold air flow proximate the floor,

(ii) preventing fogging which obscures visibility through the window,

(iii) preventing damage to window frame elements from standing water on such frame elements, and

(iv) preventing mold and mildew.

The first two objectives represent comfort and convenience factors which have different values to different people, whereby these objectives may not need to be achieved in all instances. The primary objective is to prevent damage to window frame elements and the associated wall structure such that the windows need not be replaced before they serve their expected use life and the wall structure is not damaged.

Since the first and second stated objectives are less important, and can be compromised as desired, the air flow rate and frequency can be set to ignore these factors if and as desired by a given user, though such objectives typically are pursued. Where light-sensitive sensors are used, the invention is permissive of some condensation forming on the windows, so long as the amount of condensation is not so great that droplets coalesce and flow to the bottom of the glass and onto the sash or window frame, thus achieving the primary objective of preventing rotting of the wood. Overall, typically all four objectives are pursued, and can be achieved.

A first critical feature distinguishing this invention from general space heating, using e.g. a central heating system, is that air handling, and air handlers, of the invention express their air flow only onto/along the inner surfaces of the windows and only within the confines of the heights and widths of the windows, and only at heat exchange rates which are generally insufficient to meet the space heating needs of the adjacent areas inside the building.

A second critical feature distinguishing this invention from general hot-air space heating, using e.g a central heating system, is that the rate of air flow expressed onto the window glazing by air systems of the invention is substantially lower than the rates of air flow from air diffusers used in conventional central hot-air central building heating systems.

The following are exemplary, and not limiting, parameters representative of how an air handler of the invention can service a window which fits a nominal 10 square foot opening in a building, and expressing the air onto the window glazing, and across substantially the full length and width of the window glazing:

| | |
|---|---|
| Window nominal size | 10 square feet |
| Inside air temperature | 75 F. |
| Inside air relative humidity | 50% |
| Outside air temperature | −76 F. |
| Air Temperature differential | 126 F. |
| Air heated in the air handler | Yes |
| Air pressure drop | .08 inch water in 10 feet, |
| | allowing for two 90 degree |
| | bends |
| Air flow rate at outlet grill - volumetric | 24 cubic feet per minute |
| Air flow rate at outlet grill - linear | 350 linear feet per minute |

The above-recited air flow rates are considered “gentle” air flow rates within the scope of the invention. Such air flow rates, passing through conventional air diffusers, are generally not distracting to people in the same room. The volumetric and linear rates of gentle air flow, of course, depend on the assumed parameters, whereby air flow rates and/or heat input are adjusted accordingly within the capabilities of the air handler and/or the air handling system.

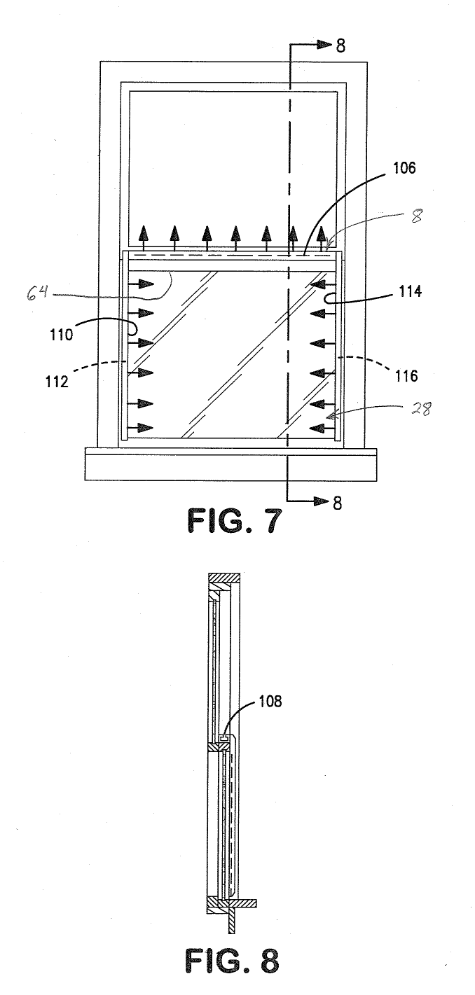

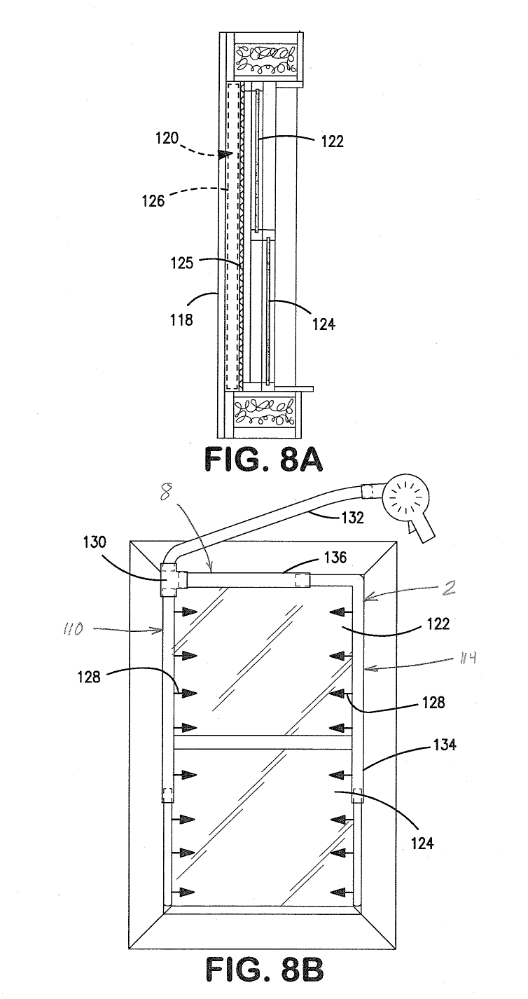

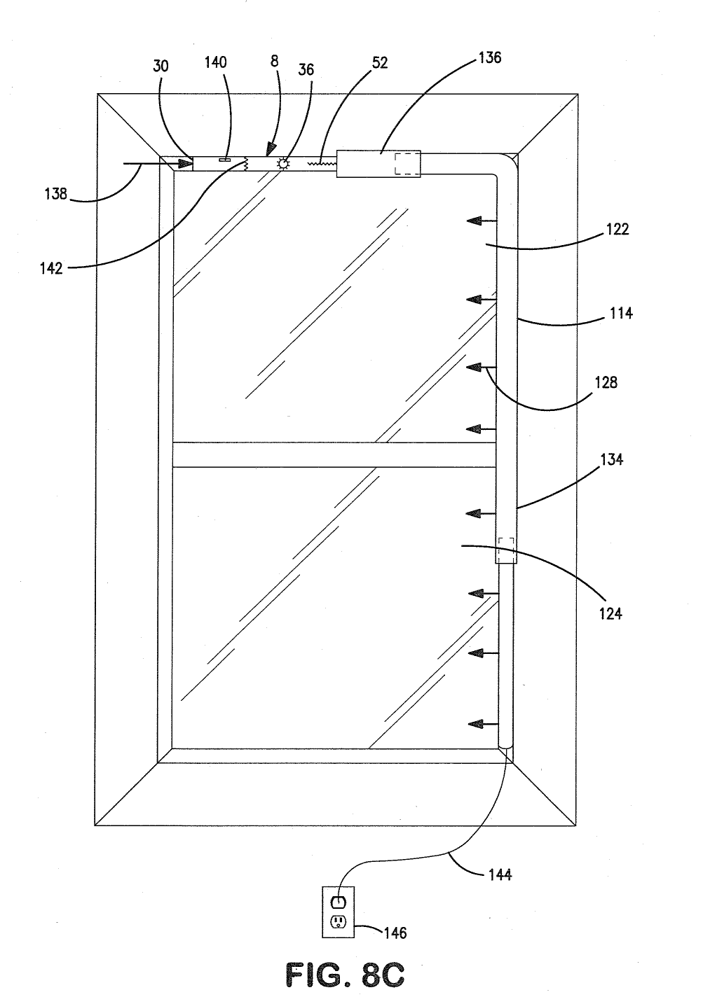

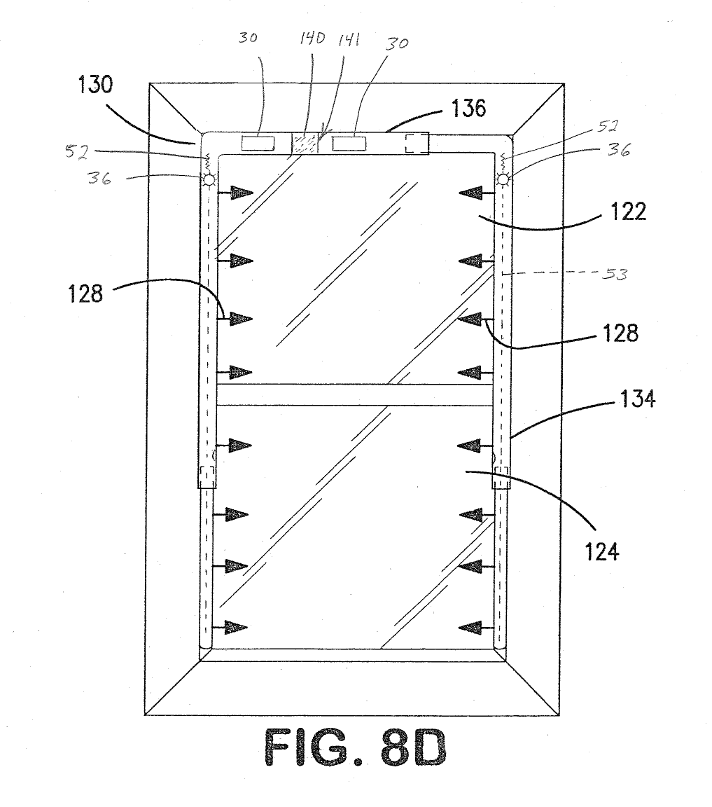

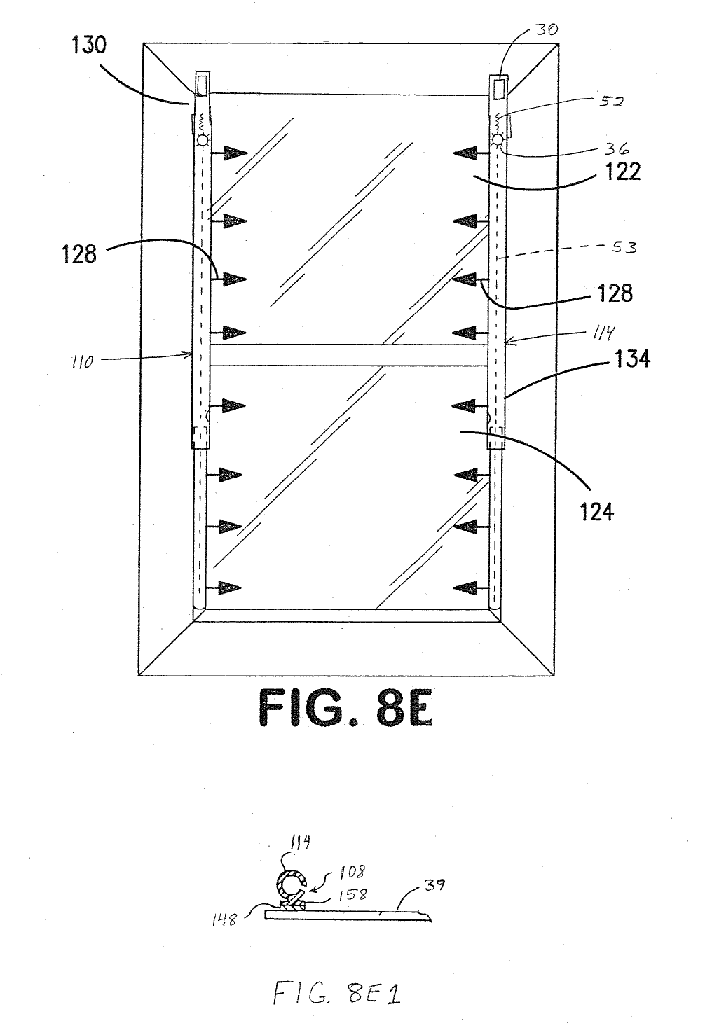

FIG. 7 illustrates yet another portable version of air handlers of the invention. FIG. 8 is a reduced-size cross-section taken at 8-8 of FIG. 7. Looking at the combined front and cross-section views in FIGS. 7 and 8, a generally horizontally-extending housing 8 is mounted to the top surface of the upper element 64 of lower sash 28. Housing 8 is made from 1.5 inch inside diameter PVC tubing. Housing 8 extends generally from the left side of the lower sash to the right side of the lower sash, from generally the front side of the upper sash frontwardly to the front side of the lower sash, and from the top of the lower sash to the bottom of the glazing in the upper sash. Housing 8 has a row of air inlet openings 106 at the upstanding surface of the housing which faces away from the window and into the room, and extending along the full width of the housing. Air inlet openings 106 generally correspond to the air inlet openings in air inlet grill 30. Housing 8 also has a row of air outlet openings 108 at the top of the housing and extending along the full width of the housing. Air outlet openings 108 generally correspond to the air outlet openings in air outlet grill 32. Each of the air inlet openings and air outlet openings is approximately 1.5 inches long and about 0.25 inch wide, and the openings are spaced longitudinally from each other by about 0.25 inch.

Housing 8 contains a first air chamber 37 which extends the full length of the housing between the left and right sides of the window. Inside chamber 37, housing 8 has one or more fans, and one or more baffles, generally as illustrated in FIG. 1A, as well as one or more optional heating units, also as illustrated in FIG. 1A.

A left leg 110 depends downwardly from the left end of housing 8. Leg 110 extends frontwardly over the front surface of the lower sash and extends thence downwardly along the left side of the lower sash generally adjacent the front of the lower sash, to the vicinity of window sill 4.

In the illustrated embodiment, left leg 110 is made of the same PVC tubing material as housing 8, and the air chamber 112 inside left leg 110 connects with, communicates freely with, chamber 37 in housing 8 at the left end of housing 8. Air outlet openings, corresponding to the air outlet openings in housing 8, are arrayed along the length of left leg 110 adjacent the glazing in lower sash 28, and are adapted to direct an outlet air flow in a rightward direction onto and across the glazing. Structure and sizing of the air outlet openings in the left leg are generally the same as the structure and sizing of the air outlet openings in housing 8.

A right leg 114 depends downwardly from the right end of housing 8. Right leg 114 extends frontwardly over the front surface of the lower sash and extends thence downwardly along the right side of the lower sash generally adjacent the front of the lower sash, to the vicinity of window sill 4.

In the illustrated embodiment, right leg 114 is made of the same PVC tubing material as housing 8, and the air chamber 116 inside right leg 114 connects with, communicates freely with, chamber 37 in housing 8 at the left end of housing 8. Air outlet openings, corresponding to the air outlet openings in housing 8, are arrayed along the length of right leg 114 adjacent the glazing in lower sash 28, and are adapted to direct an outlet air flow in a leftward direction onto and across the glazing. Structure and sizing of the air outlet openings in the right leg are generally the same as the structure and sizing of the air outlet openings in housing 8.

In consonance with the operation of the one or more blowers, the one or more baffles, and the optional one or more heating units, ambient-temperature room air is drawn into chamber 37 at air inlet openings 106 in housing 8. The one or more blowers, in combination with the chambers 37, 108 and 116, are sized and configured such that, when the blowers are running at steady state condition, a generally uniform air pressure is set up inside all three of air chambers 37, 108, and 116, whereby a generally equal quantity of air is expressed onto both of the respective upper and lower sashes. The air is heated as necessary to achieve the desired relief from fogging of the window glazings.

In the embodiment illustrated in FIGS. 7 and 8, the air handling unit is mounted only to the lower sash such as by hook and loop fasteners, or other conventional methods of attachment, and no structural element of the air handling unit extends substantially above housing 8. Accordingly, the lower sash can be raised in the conventional manner of “opening” the window, and the air handling unit moves with the lower sash, and without the air handling unit interfering with the act of opening or closing the window.

Thus, the air handling unit of FIGS. 7 and 8 can be permanently mounted to the top surface of the lower sash, and e.g. plugged into the national grid at an electrical receptacle adjacent the window, with a wire drape adequate to accommodate the movement of the air handling unit which accompanies the opening of the window.

FIG. 8 shows a cross-section of the window of FIG. 7, showing housing 8 of the air handier on top of the upper element 64 of the lower sash, and the legs extending frontwardly from housing 8 and downwardly in front of, and adjacent, the lower sash.

### EXAMPLE

FIGS. 8A and 8B illustrate a test set-up which was used for testing an air handler of the invention similar to the one described with respect to FIGS. 7 and 8. FIG. 8A shows a cross-section of the test set-up. FIG. 8B shows the same test set-up in front elevation view. The cross-section of FIG. 8A reveals a conventional double-hung window mounted in a conventional sash, and held in typical 6-inch nominal framing. The outside of the window frame is boxed in and filled with conventional fiberglass insulation, thus to simulate a conventional window installation in typical residential construction.

On the rear of the window structure is mounted a rear closure panel 118 which closes off the rear of the window from the ambient environment, thus creating a chilling cavity 120.

The window unit as tested was 2 feet wide by 3 feet tall. U-values for the upper and lower glazings 122, 124 were 0.35W/m*K.

Before start of the tests, the rear surface of the window frame was covered by four layers of standard e.g. d-flute 3-layer corrugated cardboard 125 such that the cardboard was about 0.25 inch to about 0.5 inch from the rear of the glass. The overall thickness of the cardboard was about 0.38 inch. Pellets of dry ice 126, shown in dashed outline in FIG. 8A, were then loaded into the cavity 120 between closure panel 118 of the test bed and the rear surfaces of the cardboard such that the dry ice was in surface-to-surface contact with the rear surface of the cardboard at all times during the tests. The weight of the dry ice was also bearing on the rear surface of the cardboard such that the cardboard was somewhat deflected toward the glass.

An air handler 2 was mounted to the front of the window, Air handler 2 had a header housing 8 mounted to the sash at the top of the sash. Left and right legs 110 and 114 extended from header housing 8, downwardly along the left and right edges of the window, in front of, and adjacent, the sash framing. Legs 110 and 114 extended generally straight down from housing 8 at the top of the window to terminal ends adjacent the bottom of the glazing. Thus, the legs were generally tight against the lower sash and spaced from the upper sash by a distance which corresponded to the front-to-back thickness of the lower sash.

Housing 8 had an air chamber 37. Left and right legs had air chambers 112 and 116, both connected to air chamber 37 for passage of air from chamber 37 to chambers 112 and 116.

Air outlet openings 108 as in FIGS. 7 and 8 extended along the lengths of legs 110 and 114. The air outlet openings were configured generally as in the embodiments described with respect to FIGS. 7 and 8, with the openings being oriented and directed so as to express outlet air horizontally onto the window glazing, as shown by arrows 128.

An input T-adapter 130 was assembled to housing 8 at the left side of the top of the window. Flexible tubing 132 was connected to adapter 130. Tubing 132 was connected to the outlet of a commonly-available personal-care hair dryer such that the air and heat output of the hair dryer was fed into chamber 37 when the hair dryer was turned on. The purpose of the test was to demonstrate that low velocity air, with optional use of heat, can be used to control fog on a window under even very adverse outside weather conditions.

At the start of the test, dry ice was loaded into chilling cavity 120 and was positioned against the glazings. The dry ice was maintained in constant contact with the glazings throughout all testing. The following Table 1 shows the conditions of the test, and the resulting control of fog on the window glass.

As shown in Table 1, as the test started, the test bed was stabilized at room temperature of about 75 degrees for 10 minutes. Then the dry ice was added to cavity 120. At that point, relative humidity was 25%, air velocity from the outlet slots was “0”, room temperature was 75F, slot temperature air was 75F, temperature on the inside surface of the upper window glass immediately dropped to 43F, temperature on the inside surface of the lower window glass immediately dropped to 16F, and temperature on the outside surfaces of the glass, indicated in the data as screen temperature, immediately dropped to −48F. Within 2 minutes after loading the dry ice into cavity 120, condensation began forming on the glass, with temperatures on the glass surfaces having generally not changed. Within 5 minutes after loading the dry ice into the cavity, frost was present on the glass, and glass temperatures had dropped modestly.

The test system was then held constant for 24 minutes whereupon the dryer was turned on with high heat. Table 1 shows that air velocity at the slots was 767 feet/minute, and temperature leaving the air slots was 75 degrees but had risen to 92 degrees six minutes later. Also six minutes later, concurrent with the rise in the slot temperature, the frost had disappeared from the glass such that there was no condensation, no frost on the window. The window had been freed from condensation in six minutes.

The same condition of high heat, and the same air velocity, was held for about 1 hour, with no change in condition of the glass. Then room relative humidity was raised to about 45% and the heater on the hair dryer was switched to low heat, maintaining the same air velocity. In ten minutes, a low level of condensation appeared on the glass. Then the hair dryer was turned off and within 5 minutes the glass showed a medium level of condensation. While maintaining the higher room humidity, the hair dryer was again turned on with high heat. Over a period of 44 minutes, the extent of the condensation gradually diminished until the glass was again clear of all condensation, in the presence of about 45% relative humidity.

Table 1 gives the data collected, as well as representing the levels of condensation and the hair dryer settings at the respective times.

The data collected during the above test was then analyzed to project the combination of a slot air temperature, linear air velocity needed at that air temperature to prevent condensation, inside duct diameter to maintain specified linear air velocity with 0.08 inch water pressure drop, and heater output required to maintain the specified temperature at the specified linear air velocity, all for a series of double-hung windows under the following conditions:

| | |
|---|---|
| Pressure drop, 10 ft duct length, | 0.08 inch water |
| including two 90-degree turns | |
| Indoor dry bulb temperature | 75 F. |
| Relative humidity | 50% RH |
| Outer window surface temp | −76 F. |
| Required temp of glass inner surface | 55.2 F. |
| Window overall U-value | 0.35 W/m * K |

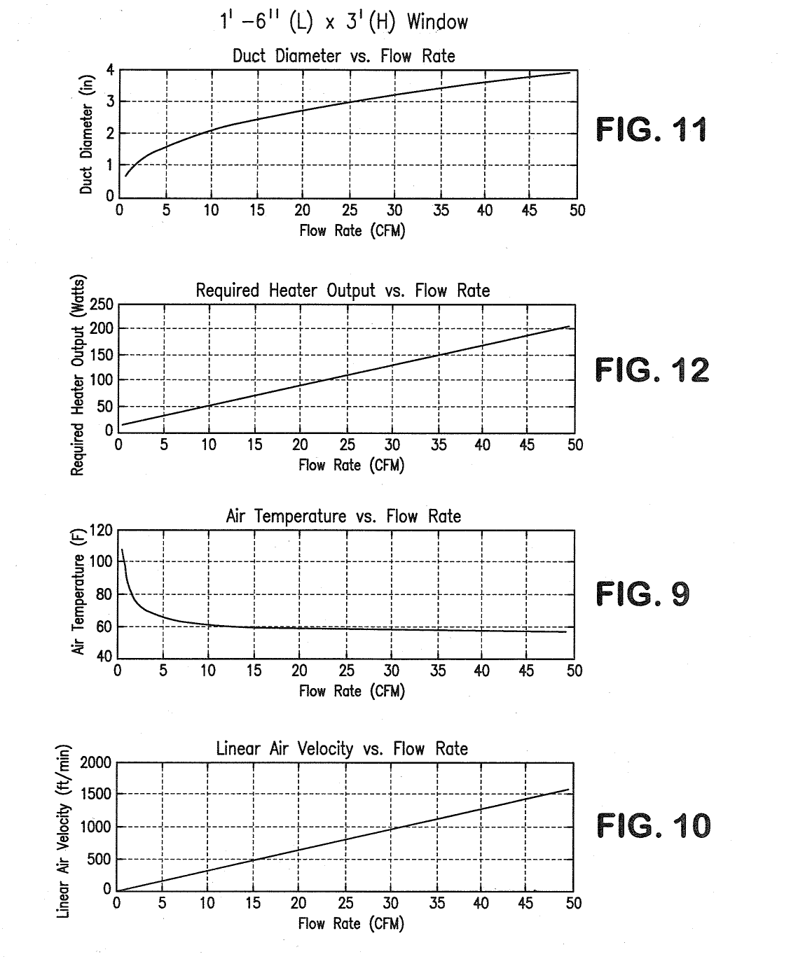

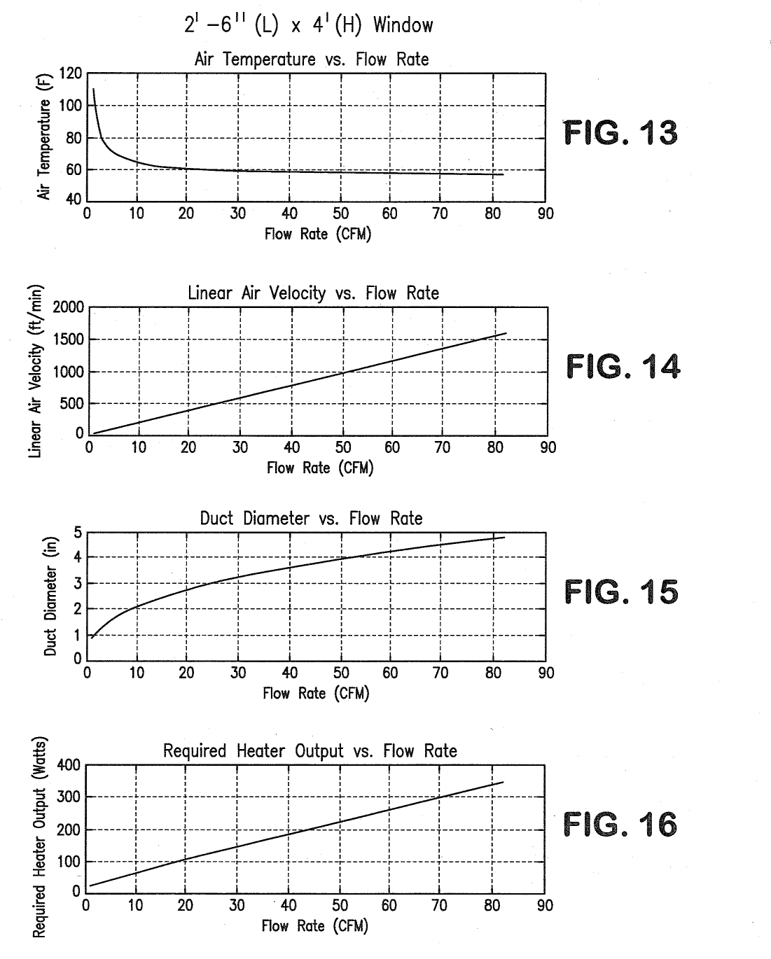

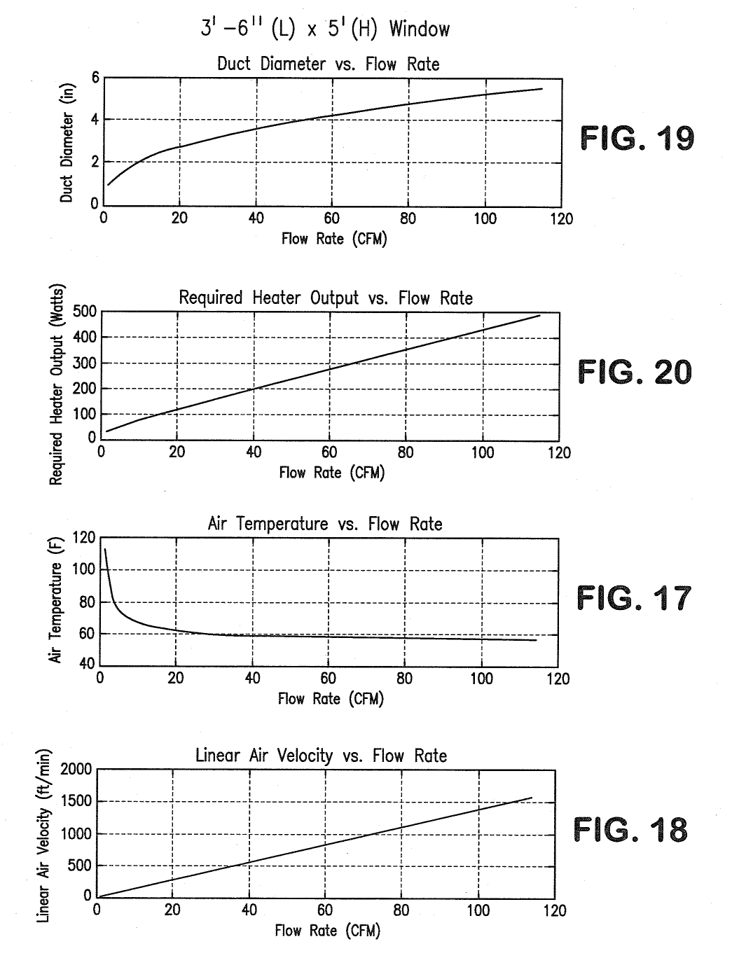

As illustrated in FIGS. 9-20, air temperature is a significant factor only at very low air flow rates. For example, for a 10 square foot window, FIGS. 13-16 show that the glass can be maintained clear under the following operating conditions:

air temperature at the outlet slots, about 65 degrees F.

air velocity, about 200 ft/min,

air volume, about 10 CFM,

duct diameter, about 2 inches,

heater output, about 70 watts.

FIGS. 9-12 and 17-20 illustrate similar requirements for the same parameters, adjusted somewhat for the different window sizes. Those skilled in the art will readily see that the respective parameters, especially air temperature, air velocity, and air volume, can be manipulated with respect to each other in order to devise a particular set of desired operating parameters.

The parameters shown in FIGS. 9-20 represent operating under very severe conditions. For more typical weather conditions in temperate climates, air temperatures, air velocity, and air volume can be measurably less, whereby less robust air handlers can readily be specified and engineered for anticipated actual, less demanding, climate conditions.

FIGS. 9-12 and Table 1 together indicate that, in moderate winter weather conditions of the temperate climate zones, air handlers of the invention can be used with relatively low air velocities, using room-temperature air as drawn into inlet grill 30, without use of any external heat input.

While the rate of flow of air fro the outlet grill is relatively modest, the rate is sufficiently great as to affect the temperature of the window along substantially the full dimension of the window from the outlet grill to the distal side of the glazing. Thus, where the outlet grill is at the bottom of the glazing, the air expressed from the outlet grill affects the full height of that glazing. Where the outlet grill extends along a single side of the window, the air expressed from the outlet grill affects the full width of the respective glazing. Where there are outlet grills on opposing sides of a given glazing, the air expressed from the outlet grills, collectively, affects the full width of the respective glazing. Wherever the outlet grill, whether there is one outlet grill or more than one outlet grill, the outlet grill design and configuration collectively enable the air handler to provide functional air flow to all areas of the window which are susceptible of experiencing condensation under the operating conditions to which the window is expected to be exposed in routine use in the anticipated environment.

As can be seen from the various embodiments illustrated in the drawings, air handlers of the invention are designed differently for specific classes of windows, such classes as double hung windows, fixed-pane windows, casement windows, awning windows, and the like. The air handlers are also designed differently where the air handler is incorporated into the window structure, itself, as opposed to stand alone air handlers which can be mounted on an exposed surface of the window structure.

FIG. 8C illustrates a double hung window having an air handler of the invention mounted to the front of the window. Air inlet 30 is generally on the left side of header housing 8. Arrow 138 generally represents flow of air into inlet 30. Adjacent air inlet 30 is a computer chip 140 which controls operation of the air handler, and an air filter 142. Inwardly of the air filter are blower 36 and heater 52. Air is drawn into the header at inlet 30 by the action of blower 36. The air passes through filter 138 and past heater 52 on the way to leg 114. The air is expressed from leg 114 through slots 106 which operate as a linearly-extending air outlet grill 32. Both the header and the leg have telescoping sections which accommodate extending and retracting the leg and/or header in length to accommodate use of the air handler with/on windows having a variety of lengths and widths. A power cord 144 is illustrated extending from leg 114, and plugged into a receptacle 146 which connects to the national power grid or other electrical source.

FIG. 8D shows yet another embodiment of air handlers of the invention. As illustrated in FIG. 8D, the air handler includes a telescoping header 8 and left and right telescoping legs 110 and 114 extending downwardly from the header, Computer chip 140 is co-located with a physical barrier 141 which physically separates the left side of header chamber 37 from the right side of header chamber 37 such that air cannot pass between the left side of chamber 37 and the right side of chamber 37. Left and right air inlets 30 are disposed on opposing sides of barrier 141 so as to provide for admission of air into the two chambers 37 on the left and right sides of barrier 141.

Air chambers extend substantially the full telescoped lengths of legs 110, 114, and have gaseous communication with chamber 37 in header 8. First and second blowers 36 are disposed inside the air chambers in legs 110, 114. In the alternative, the blowers could be located in the left and right portions of chamber 37 in header 8.

First heaters 52 are disposed in each of the air paths between the respective air inlets 30 and the uppermost ones of the air outlet apertures in legs 110, 114. A second supplementary heater 53 is disposed in each of legs 110, 114 between the respective blower 36 and the most remote one of the air outlet apertures in the respective leg.

As in the earlier examples of the invention, operation of the air handler can be controlled by manually operated switches, or can be controlled by e.g. a computer chip 140. In any event, the blowers 36, the first heaters 52, and the second heaters 53 can each be individually controlled so as to maintain the window with little or no condensation on the glass while limiting the amount of energy used.

FIG. 8E shows a front elevation view as in FIG. 8D but wherein the header 8 has been omitted. Thus the essence of the embodiment of FIG. 8D is first and second legs 110, 114, each mounted separately, vertically to the window, adjacent the left and right sides of the sashes/glasses. Each leg has its own needs for electrical power for operation of its blower 36 and its heaters 52, 53. For example, each leg has a power cord (not shown) for connecting to an electrical outlet. Each leg has an air inlet 30 at or near the top of the leg for admitting air into the leg. Each leg has a set of air outlet apertures for expressing air onto and across the glass as illustrated by the arrows 128.

Thus, a given window may be adequately protected from condensation by mounting a single one of legs 110 or 114 to either side of the window. Where the temperature gradient between inside and outside is especially harsh, or for relatively wider windows, legs on both sides of the window can advantageously be used. Thus, by providing air inlet, heater, and blower in each leg, the user can simplify the need for servicing a variety of window sizes, in a variety of use conditions, by applying either one or two of the air handlers of FIG. 8E to a particular window.

Advantageously, such legs are installed with the air inlets disposed upwardly. Heaters 53 are optional, and are controlled separate from the control of heaters 52 whereby heaters 53 can be used to provide supplementary heat when suggested by adverse temperature/weather conditions.

FIG. 8E1 shows a cross-section of one of the legs 110, 114, and mounting structure mounting the leg to the window frame 39. A mounting element 148, such as double-sided tape, hook and loop fasteners, or the like, is interposed between a mounting foot 158 on the leg and the window frame 39. While it is contemplated that the air handler, once mounted to a window, will not be moved, use of a releasable such mounting structure such as hook and loop fasteners can accommodate a temporary such mounting as desired.

While the air handlers illustrated herein have illustrated air being expressed onto the glass from both left and right sides of the glass, it is contemplated that relatively narrower windows can be kept free of condensation by air expressed from only the left side, or from only the right side, and that with relatively wider windows, the air should be expressed from both sides in order to ensure that the windows remain fog-free. The actual requirements for a given window include considerations of window structure as well as the expected operating environment within which the window will be functioning, and generally represent a balancing of structure, air flow parameters, and heat applied to the outlet air. Greeter linear footage of air outlet grill and/or air temperature typically accommodate relatively lower air flow rate. Greater air flow rates generally accommodate relatively lower temperature and/or relatively smaller air outlet linear footage.

Where the air handler is not incorporated into the window, but rather is mounted to an external surface of the window, the header and any leg or legs can be telescoped as illustrated in e.g. FIG. 8B at 134 and 136 such that any one air handler can be adjusted to fit a range of window lengths and widths.

Accordingly, now that the invention has been described for various of such embodiments, those skilled in the art can now readily design air handlers of the invention, and methods for use of such air handlers, for any desired window class, or for custom window structures, without departing from the spirit of the instant invention. And while the invention has been described above with respect to the preferred embodiments, it will be understood that the invention is adapted to numerous other rearrangements, modifications, and alterations, and all such arrangements, modifications, and alterations are intended to be within the scope of the appended claims.

To the extent the following claims use means plus function language, it is not meant to include there, or in the instant specification, anything not structurally equivalent to what is shown in the embodiments disclosed in the specification.

Having thus described the invention, what is claimed is:

1. A window air handler adapted to attenuate moisture condensation on a glazing of an installed window in a building, such window including a glazing, such window having a top and a bottom, a left side and a right side, a height between the top and the bottom, a width between the left side and the right side, and an inside glazing surface facing an interior of such building, said window air handler being external to, and separate and distinct from, such window, and comprising:
(a) a header (136);
(b) a first leg extending down from said header and alongside more than half the height of such glazing;
(c) an air inlet adapted to admit air from an ambient environment inside such building proximate the top of such window when at least one of said header and said first leg is mounted to one of such window or such building such that said header is proximate the top of such window;
(d) an air outlet structure comprising a first set of o or more air outlet apertures in said first leg, below said air inlet;
(e) an air flow path between the air inlet and the air outlet apertures whereby air enters said air handier proximate the top of such window and flows downwardly to the air outlet apertures, below the air inlet; and
(f) a blower in the air flow path between the air inlet and at least one of the air outlet apertures, said blower blowing air out of said air handler at the at least two air outlet apertures.

2. A window air handier as in claim 1 wherein, when said air handler is installed at a such window, said header extends across at least a portion of the width of such window, and the air outlet apertures are spaced along a length of said first leg, with a distal such aperture being proximate a remote bottom end of said first leg.

3. A window air handler as in claim 2 wherein said blower is inside said header and above such window glazing, and above said first leg.

4. A window air handler as in claim 2 wherein said blower is inside said first leg.

5. A window air handler as in claim 2 wherein said first leg extends alongside such window for substantially the full height of said window.

6. A window air handler as in claim 5 wherein a relatively smaller cross-section remote portion of said first leg is slidably and telescopically received into a relatively larger cross-section proximal portion of said first leg, the remote portion of said first leg having a first length and the proximal portion of said first leg having a second length, whereby the remote portion of said first leg can be extended from, and retracted into, the proximal portion of said first leg, and wherein at least one of the outlet apertures is disposed in each of the remote portion of said first leg and the proximal portion of said first leg.

7. A window air handler as in claim 6, said header having a useful width sufficient to extend across the width of such window, and wherein said header extends along the top of such window, from a left side of such window to a right side of such window, and wherein a relatively smaller cross-section first portion of said header is slidably and telescopically received into a relatively larger cross-section second portion of said header, whereby the first portion of said header can be extended from, and retracted into, the second portion of said header, whereby said header can be telescopically adjusted in width across the width of such window, and said first leg can be telescopically adjusted in height along the height of such window.

8. A window air handler as in claim 5, further comprising a heater in said downwardly-extending first leg.

9. A window air handier as in claim 6, said first leg having a useful length sufficient to extend substantially the full height of such window, down along the right side of such window,
further comprising a second telescoping leg, in gaseous communication with said header and extending down along the left side of such window, said second leg having a second set of air outlet apertures expressing air onto such window glazing from the left side of such window.

10. A window air handler as in claim 9, said air inlet comprising a first air inlet between a relatively central portion of the width of said header and an uppermost one of the air outlet apertures in said first leg, and thus providing for air flowing through said first leg,
further comprising a second air inlet between the central portion of the width of said header and an uppermost one of the air outlet apertures in said second leg, and thus providing for air flowing through said second leg.

11. A window air handler as in claim 10, said blower being disposed between the first air inlet and the first set of outlet apertures in said first leg, further comprising a second blower between the second air inlet and the second set of outlet apertures in said second leg, an air flow barrier being disposed in said header between said first and second blowers such that air flowing between the first air inlet and the outlet apertures in said first leg is segregated from the air flowing between the second air inlet and the outlet apertures in said second leg.

12. A window air handier as in claim 11, further comprising first and second sensors sensing condensation conditions at first and second spaced locations on such glazing of the given window in association with respective air flows being expressed from the air outlet apertures in said first and second legs, and a controller receiving condensation condition information from said first and second sensors, and controlling operation of said first blower according to the information received from said first sensor, and separately controlling operation of said second blower according to the information received from said second sensor.

13. A window air handler as in claim 12, said heater in said first leg comprising a first heater, further comprising a second heater in said second leg, said controller separately controlling output of said first heater and output of said second heater according to the information received from said first and second sensors, respectively.

14. A window air handler as in claim 1, said header having a useful width sufficient to extend across the width of such window, and wherein said header extends along the top of such window, from the left side of such window to the right side of such window, further comprising a first heater between the air inlet and said blower, and a second heater between said blower and a remote end of said first leg.

15. A window air handler as in claim 14 wherein said second heater extends between a location proximal such blower and a location proximate such outlet aperture which is most remote from said blower.

16. A window for use in a building, said window having a top and a bottom, a left side and a right side, a height between the top and the bottom, a width between the left side and the right side, and an inside glazing surface facing an interior of such building, said window comprising:
(a) a window frame;
(b) a window sash; and
(c) a window air handler mounted to at least one of said window frame and said window sash, said window air handler comprising
(i) a first telescoping leg extending down along either the left side or the right side of said window, a relatively smaller cross-section lower portion of said first leg being slidably and telescopically received into a relatively larger cross-section upper portion of said first leg, whereby the first lower portion of said first leg can be extended from, and retracted into, the upper portion of said first leg,
(ii) a first air inlet proximate the top of said first leg,
(iii) as a first air outlet structure, a first set of two or more air outlet apertures in said first leg, below the first air inlet, and
(iv) a first blower in said first leg, said first blower blowing air out of said first leg at the first set of two or more air outlet apertures and onto and across the inside glazing surface of said window,
whereby air enters said air handler at the first air inlet and travels downwardly inside said first leg along the respective side of said window and is expressed from said first leg and onto and across the inside glazing surface of said window at locations below the first air inlet.

17. A window as in claim 16, further comprising a first heater between said first air inlet and said first blower, and a second heater between said first blower and a remote end of said first leg.

18. A window as in claim 16, said window air handler further comprising a second telescoping leg separate and distinct from said first telescoping leg and mounted to one of said window frame and said window sash at the other of the left side or the right side of said window, said second telescoping leg having a second upper end proximate the top of said window and a second lower end displaced from the top of said window, a relatively smaller cross-section lower portion of said second leg being slidably and telescopically received into a relatively larger cross-section upper portion of said second leg, whereby the second lower portion of said second leg can be extended from, and retracted into, the upper portion of said second leg, said second leg having a second air inlet proximate the top of said second leg and an air outlet structure comprising a second set of two or more air outlet apertures in said second leg, below the second air inlet.

19. A window as in claim 18, further comprising a third heater between said second air inlet and said second blower, and a fourth heater between said second blower and a remote end of said second leg.

20. A window as in claim 19, further comprising a first condensation sensor sensing condensation on such window proximate said first leg and a second condensation sensor sensing condensation on such window proximate said second leg, and a controller receiving input from both of said first and second sensors, said controller sending a first set of control signals to said first blower and said first heater in said first leg in response to input from said first sensor, and sending a second set of control signals to said second blower and said second heater in said second leg in response to input from said second sensor.
